(19) United States
(12) Patent Application Publication
(10) Pub. No.: US 2014/0311659 A1
(43) Pub. Date: Oct. 23, 2014

(54) CORRUGATED PROCESSING UNIT AND METHOD THEREOF

(71) Applicants: Giuseppe BRIVIO, BESANA BRIANZA (Monza Brianza) (IT); Renato ROSSI, BIASSONO (Monza Brianza) (IT)

(72) Inventors: Giuseppe BRIVIO, BESANA BRIANZA (Monza Brianza) (IT); Renato ROSSI, BIASSONO (Monza Brianza) (IT)

(73) Assignee: ITALDRY S.r.L., BRIOSCO (Monza Brianza) (IT)

(21) Appl. No.: 13/866,521

(22) Filed: Apr. 19, 2013

(51) Int. Cl. B31F 1/28

(52) U.S. Cl. CPC B31F 1/285; B31F 1/28; B31F 1/2804
USPC 156/205; 156/471

(57) ABSTRACT

Provided is a unit for manufacturing corrugated board from sheets of paper material, including: corrugation means configured to heat-corrugate a first sheet of paper material to make a corrugated sheet, heating means configured to heat sheets of paper material to provide the heat needed to optimise at least the processing performed by the corrugation means, first gluing means configured for joining, by hot gluing the corrugated sheet to a second sheet of smooth paper material to make a compound corrugated sheet, second gluing means configured for joining, by hot gluing, the compound corrugated sheet to a final sheet to make corrugated board, the first gluing means and the second gluing means are positioned next to the corrugation means, so that the first heating means are able to supply at least a predominant part of the heat needed by the first gluing means and the second gluing means.

### TECHNICAL BACKGROUND OF THE INVENTION

The present invention relates to a unit for making corrugated board from sheets of paper material, comprising: corrugation means suitable to heat-corrugate a first sheet of paper material to make a corrugated sheet, heating means suitable to heat said sheets of paper material to provide the heat needed to optimise at least the processing performed by the corrugation means, first gluing means suitable for joining, by hot gluing, the corrugated sheet to a second sheet of smooth paper material to make a compound corrugated sheet, second gluing means suitable for joining, by hot gluing, said compound corrugated sheet to a final sheet to make corrugated board.

### DESCRIPTION OF THE PRIOR ART

Corrugated board is composed of a plurality of coupled sheets, alternately corrugated and smooth, so as to lend structural resistance to the finished material, called namely corrugated board.

Traditionally, corrugated board is composed of two flat sheets enclosing a corrugated sheet, or of three flat sheets with two corrugated sheets interspersed between them.

Plants for producing corrugated board are described for example in the patent application EP-A-1820899.

They form the corrugated board starting from sheets which pass through corrugation units and a gluing unit.

Specifically, the corrugation units provide for the heating of two sheets, the corrugation of at least one of the two sheets which constitutes an intermediate corrugated sheet and the immediate gluing, with simultaneous heating, of the two sheets to form a compound corrugated sheet.

In particular the corrugation units provide a first corrugation calender, composed of two rollers with corrugated surfaces suitable to corrugate the paper, and a second gluing calender, composed of one of the two rollers of the corrugation calender and of one smooth roller. Each of said rollers with corrugated surfaces is preferably made from steel and heated inside by means of vapour, so as to perform the said formation and said hot gluing of the corrugated sheet. A gluing roller is positioned between the two calenders, suitable to supply itself with glue and spread it on the crests of the corrugated paper.

The compound corrugated paper made passes through a long portion of the plant for a period of time varying from 10s to 100s and is fed into a gluing unit where it is glued to a smooth cover and, if necessary, to other compound corrugated sheets.

In such gluing unit the compound corrugated sheet is first heated, by the passage of a roller heated internally with steam, and then moved to a further gluing roller, also suitable to supply itself with glue and spread it on the remaining crests of the corrugated paper, after which it is lastly moved to a flats unit where one or more compound corrugated sheets and a cover are physically joined.

The joining of the compound corrugated sheets and the cover is performed by a joining calender and by means of a so-called flats unit. The latter contributes further heat and steam which helps to complete the gluing and define further properties, such as the correct planarity.

The prior art described above has several significant drawbacks.

In fact, the units described for making corrugated board provide for two subsequent heating steps of the sheets of paper: one to make the corrugated sheet and join it to a first cover and smooth sheet, and another to join it to the second cover.

However, such double heating step, needed to perform the two separate hot gluing steps, entails high energy consumption.

In addition, the double heating deteriorates the papers used, considerably detracting from the quality of the visible surfaces of the corrugated board.

Lastly, said units occupy a great deal of space to perform all the aforesaid processing.

### SUMMARY OF THE INVENTION

In this situation the technical purpose of the present invention is to develop a unit and a method for making corrugated board able to substantially overcome the inconveniences mentioned above.

Within the sphere of said technical purpose one important aim of the invention is to obtain a unit and a method for making corrugated board requiring a reduced supply of thermal energy.

Another important aim of the invention is to make a unit and a method for making corrugated board which permits high quality of the finished product to be achieved.

A further aim of the invention is to make a unit for making corrugated board which occupies less space.

The technical purpose and specified aims are achieved by a unit for making corrugated board from sheets of paper material, comprising: corrugation means suitable to heat-corrugate a first sheet of paper material to make a corrugated sheet, heating means suitable to heat the sheets of paper material to provide the heat needed to optimise at least the processing performed by the corrugation means, first gluing means suitable for joining, by hot gluing, the corrugated sheet to a second sheet of smooth paper material to make a compound corrugated sheet, second gluing means suitable for joining, by hot gluing, the compound corrugated sheet to a final sheet to make corrugated board wherein the first gluing means and the second gluing means are positioned next to the corrugation means so that the first heating means are able to supply at least a predominant part of the heat needed by the first gluing means and the second gluing means.

### BRIEF DESCRIPTION OF THE DRAWINGS

The characteristics and advantages of the invention are clearly evident from the following detailed description of a preferred embodiment thereof, with reference to the accompanying drawings, in which:

FIG. 1 shows the unit according to the invention in a schematic view; and

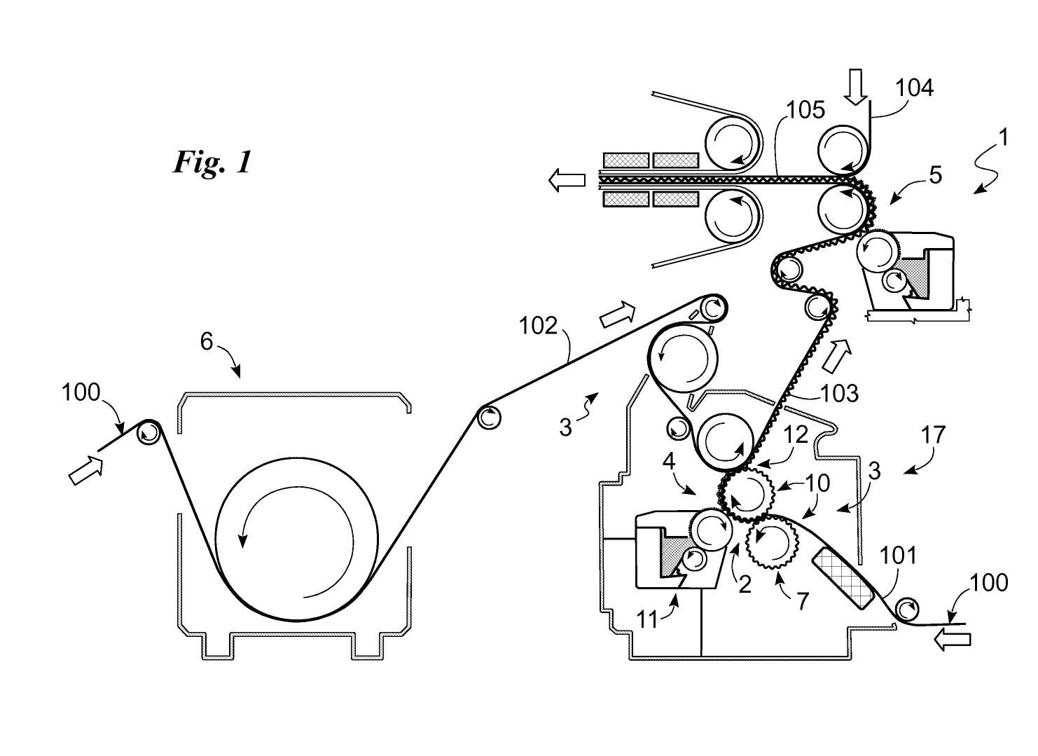

FIG. 2 shows a portion of the unit according to the invention in a schematic view.

With reference to the drawings cited, reference numeral 1 globally denotes the unit for processing corrugated board according to the invention.

It is suitable to make corrugated board 105, comprising at least one corrugated sheet enclosed by two covers, starting from sheets of paper material. 100. In this patent the term sheets of paper material 100 is understood to mean any sheet or compound of sheets, at any stage of processing.

The unit 1 comprises, in brief: corrugation means 2 suitable to heat-corrugate sheets of paper material 100, heating means 3 suitable to heat sheets of paper material 100 to provide the heat needed to optimise at least the processing performed by the corrugation means 2, first gluing means 4 and second gluing means 5, suitable for joining, by hot gluing, a plurality of sheets of paper material 100 to each other.

Advantageously, in the unit 1 the first gluing means 4 and the second gluing means 5 are positioned next to the corrugation means 2, as specified further below, so that the first heating means 3 are suitable to supply at least a predominant part, and preferably the totality, of the heat needed by the first gluing means 4 and the second gluing means 5. The term predominant is understood as preferably more than 50%.

More specifically, the corrugation means 2 comprise a corrugation calender 7 composed of a first and a second corrugation roller 8 and 9 preferably hollow on the inside and made from steel. They are suitable to heat-corrugate a first sheet of paper material 101 to make a corrugated sheet 101a.

The heating means 3 are controlled by the corrugation means 2 and appropriately comprise a pre-heating station 6, in itself known, suitable for heating the second sheet of paper material 102 before it reaches the corrugation means 2. The corrugation means 2 comprise then a heating device 10 which heats said corrugation rollers 8 and 9 by means of pressurised steam fed into said rollers. Said heating means 3, and in particular the station 6 and the device 10 are preferably the only heating means present in the unit 1 and are therefore suitable to supply heat to the gluing means 4 and 5.

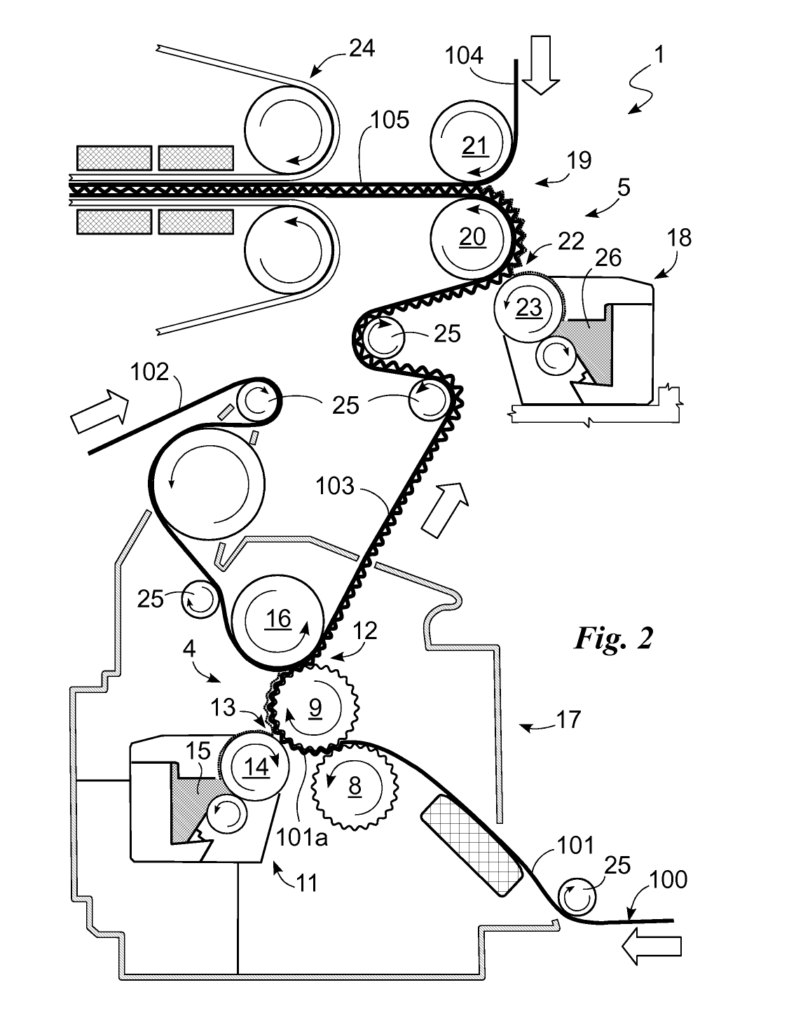

Alternatively, some of the subsequent rollers described and illustrated in FIG. 2 can also be heated internally by steam. Said inserted steam is preferably at a temperature of between 120° C. and 190° C. and at a pressure varying from 1 bar to 14 bar and preferably from 2 bar to 8 bar, such latter range in particular for paper having a paper density of 40 g/m² to 440 g/m².

Downstream of the corrugation means 2 the first gluing means 4 are positioned, which in turn include first spreading means 11 suitable to spread the glue on the corrugated sheet 101a, and a first gluing calender 12 suitable to join the corrugated sheet 101a including glue to a second smooth sheet in paper material 102 or cover, to form a compound corrugated sheet 103.

In detail, the first spreading means 11 are suitable to spread glue on the side of the corrugated sheet 101a coming into contact with the second sheet of paper material 102. These are positioned upstream of the first gluing calender 12 and next to it, so that the glue does not react before contact with the sheets.

The first spreading means 5 are preferably in themselves known and used in the manufacturing apparatus of membranes in corrugated board 105. In particular they are composed of a first spreading calender 13 composed of a first gluing cylinder 14 and of the second corrugation roller 9. The gluing cylinder 14 is suitable to fish into a first glue tank 15 and to place a layer of glue on the corrugated sheet 101a. The glue in the first glue tank 15 is preferably in a liquid state at ambient temperature.

The first gluing calender 12 is instead positioned downstream of the corrugation calender 7 and of the gluing calender 13, and is suitable for providing the pressure, and even the heat, for joining the corrugated sheet 101a including glue to the second sheet of paper material 102. It is composed of the second corrugation roller 9 and of a pressure roller 16, preferably internally heated.

The corrugation means 2 and first gluing means 4 described are structurally placed within a corrugation apparatus 17, in itself known and described for example in the European patent in EP-B-0970805, by the same applicant. Downstream of the first gluing means 4 and outside the corrugation apparatus 17 are the second gluing means 5.

These include second spreading means 18 suitable for spreading glue on the compound corrugated sheet 103, and a second gluing calender 19 suitable to join the compound corrugated sheet 103 including glue to a final sheet 104 to make corrugated board 105.

The final sheet 104 may be a simple cover, in such case the corrugated board 105 has a single corrugation and two covers, or a sheet in turn including one or more corrugations interspersed with covers and flat sheets, in which case the corrugated board 105 comprises a plurality of corrugations interspersed with flat sheets and covered by covers on the sides facing onto the corrugated board 105.

In detail, the second gluing calender 19 is positioned downstream of the second spreading means 18, and is suitable to provide the pressure, and even to provide the heat by means of internal steam, to join the compound corrugated sheet 103 including glue to the final sheet 104. It is composed of a first and a second pressure roller 20 and 21.

The second spreading means 18 are suitable to spread glue on the side of the compound corrugated sheet 103 coming into contact with the final sheet 104. These are positioned upstream of the second gluing calender 19 and next to it, so that the glue does not react before contact between the sheets.

In particular the second spreading means 18 are preferably in themselves known and the same as the first spreading means 11. They are composed of a second spreading calender 22 composed of a second gluing cylinder 23 and of the first pressure roller 20. The gluing cylinder 23 is suitable to fish into a second glue tank 26 and to place a layer of glue on the compound corrugated sheet 103. The glue in the second glue tank 15 is preferably also in a liquid state at ambient temperature.

The corrugated board 105 thus produced is sent to a flats unit 24, in itself known and suitable to complete the gluing and adjust the planarity of the corrugated board 105 by supplying heat and pressure.

The unit 1 is lastly completed by a plurality of straightening rollers 25 positioned all along the unit 1 and suitable to adjust the trajectory of the sheets of paper 100 and of the compound corrugated sheet.

The functioning of the unit 1 described above in a structural sense, is as follows.

The unit 1 is activated and the first and second sheet of paper material 101 and 102 are inserted in the paths provided defined by the straightening rollers 25.

In particular, the first sheet of paper material 101 is heated by the heating means 3 and corrugated by the corrugation means 2; the second sheet of paper material 102 passes through the station 6, is pre-heated and enters the corrugation apparatus 17 where it is heated once again by the heating means 3 reaching the first gluing means 4, which join it to the corrugated sheet 101a forming the compound corrugated sheet 103 which subsequently comes out of the corrugation apparatus 17.

The second gluing means 5 are positioned at a distance of less than 10m and preferably less than 5m from the apparatus 17 which the compound corrugated sheet 103 therefore reaches in less than 5s after coming out of the apparatus 17.

The compound corrugated sheet 103 then reaches the second gluing means 5 and is glued to the final sheet 104 forming the corrugated board 105 which is then sent to the flats unit 24.

The unit 1 is part of a plant for manufacturing corrugated board 105 and, if the corrugated board has several corrugated layers, the same unit 1 is appropriately replicated in a number of units equal to the number of corrugated layers.

The invention thus indicates a new method of manufacturing corrugated board 105 which substantially copies the functioning described of the unit globally denoted by reference numeral 1.

In particular the method comprises: a heating step in which the sheets of paper material 100 are heated to provide the heat needed to optimise at least the processing performed in said corrugation step, a corrugation step in which a first sheet of paper material 101 is heat-corrugated to make a corrugated sheet 101a, a first gluing step in which the corrugated sheet 101a is joined to a second sheet of smooth paper material 102 by hot gluing to make a compound corrugated sheet 103, a second gluing step in which the compound corrugated sheet 103 is joined to a final sheet 104 by hot gluing, to make the corrugated board 105.

Advantageously, in said method the heating step is suitable to supply at least a predominant part of the heat needed for said first gluing step and said second gluing step.

The sheets 100 are then transferred by said heating means 3 to the second gluing means 5 in less than 5 seconds.

The invention achieves some important advantages.

In fact the applicant has surprisingly discovered that a further heating station before the second gluing means 5 is not needed if the compound corrugated sheet 103 does not cool too much coming out of the apparatus 17 and thus out of the first gluing means 4 and corrugation means 2.

In fact, according to a study by the Applicant, the heat contributed by the papers 100 to the glue, in particular by the corrugated paper 101a, is sufficient to perform a further overall gluing.

The gluing may in fact be facilitated by a further contribution of heat, not predominant, given by the heated rollers or even by non-heated rollers but made from non-conductive material, such as polymer matrix composite fibre materials or the like.

The fact that there is no subsequent heating entails considerable energy saving.

In addition, the lack of the second heating reduces the deterioration of the paper improving the quality thereof.

A further advantage of no lesser importance is the fact that the plant occupies less space given that the first and second gluing stations are substantially joined spatially.

Variations may be made to the invention described herein without departing from the scope of the inventive concept expressed in the independent claims.

All details may be replaced with equivalent elements and the scope of the invention includes all other materials, shapes and dimensions.

1. A unit for making corrugated board from sheets of paper material, comprising: corrugation means configured to heat-corrugate a first sheet of paper material to make a corrugated sheet, heating means configured to heat said sheets of paper material to provide heat needed to optimise at least the processing performed by said corrugation means; first gluing means configured for joining, by hot gluing, said corrugated sheet to a second sheet of smooth paper material to make a compound corrugated sheet; and second gluing means configured for joining, by hot gluing, said compound corrugated sheet to a final sheet to make corrugated board, wherein said first gluing means and said second gluing means are positioned next to said corrugation means so that said first heating means are able to supply at least a predominant part of the heat needed by said first gluing means and by said second gluing means.

2. The unit of claim 1, wherein said heating means comprises a pre-heating station suitable configured to heat said second sheet of paper material before it reaches the corrugation means.

3. The unit of claim 1, wherein said corrugation means comprises a corrugation calender comprising a first and a second corrugation roller and wherein said heating means comprises a heating device of said corrugation rollers.

4. The unit of claim 3, wherein said rollers are hollow and wherein said heating device heats said corrugation rollers by means of steam fed inside said corrugation rollers.

5. The unit of claim 2, wherein said heating device of said corrugation rollers and said pre-heating station are the only heating means of said sheets in paper material.

6. The unit of claim 1, wherein said second gluing means are at a distance of less than 10m from said first gluing means.

7. The unit of claim 1, wherein said second gluing means comprises second spreading means configured to spread glue on the corrugated side of said compound corrugated sheet and a second gluing calender configured for joining said compound corrugated sheet to said final sheet.

8. A plant for manufacturing corrugated board comprising at least one of claim 1.

9. A method of manufacturing corrugated board from sheets of paper material, comprising: heating sheets of paper material to provide the heat needed to optimise at least the processing performed in said corrugation step; hot-corrugating a first sheet of paper material to make a corrugated sheet; first gluing said corrugated sheet to join it to a second sheet of smooth paper material by hot gluing to make a compound corrugated sheet; and second gluing said compound corrugated sheet to join it to a final sheet by hot gluing, to make corrugated board; wherein said heating is configured to supply at least a predominant part of the heat needed for said first gluing and said second gluing.

10. The method of claim 9, wherein a first gluing means and a second gluing means are positioned next to corrugation means so that sheets are transferred by said heating means to said second gluing means in less than 5 seconds.
